(19) United States
(12) Patent Application Publication
(10) Pub. No.: US 2016/0061715 A1
(43) Pub. Date: Mar. 3, 2016

(54) Photoacoustic Imager

(71) Applicant: XTrillion, Inc., Tokyo (JP)

(72) Inventor: Kazuo KITAGAWA, Tokyo (JP)

(21) Appl. No.: 14/790,257

(22) Filed: Jul. 2, 2015

(30) Foreign Application Priority Data
Aug. 27, 2014 (JP) 2014-172467

(51) Int. Cl. G01N 21/17

(52) U.S. Cl. CPC G01N 21/1702; G01N 2201/106

(57) ABSTRACT

This photoacoustic imager is configured to decide the width of a pulse on the basis of a detection sound wave frequency band of a detection portion and to decide the number of pulses in one cycle on the basis of the bandwidth of a detection sound wave frequency of the detection portion.

### BACKGROUND OF THE INVENTION

1. Field of the Invention

The present invention relates to a photoacoustic imager, and more particularly, it relates to a photoacoustic imager including a light source portion.

2. Description of the Background Art

A photoacoustic imager including a light source portion is known in general, as disclosed in Japanese Patent Laying-Open No. 2013-075000, for example.

The aforementioned Japanese Patent Laying-Open No. 2013-075000 discloses a photoacoustic image generator (photoacoustic imager) including a laser beam source emitting a pulsed laser beam to be applied to a specimen and a detection portion detecting an acoustic wave generated from a detection object in the specimen absorbing the laser beam. In the photoacoustic image generator according to Japanese Patent Laying-Open No. 2013-075000, a high-output solid laser is conceivably employed as the laser beam source.

The photoacoustic image generator according to the aforementioned Japanese Patent Laying-Open No. 2013-075000 conceivably increases the sound pressure of the generated acoustic wave by employing the high-output solid laser as the laser beam source, so that the detection portion detects the acoustic wave. However, when an LED or the like is employed as a light source in order to satisfy requirement for power saving, for example, the sound pressure of an acoustic wave generated by application of light is reduced due to reduction in the output of the light source, and hence an image obtained on the basis of the detected acoustic wave is disadvantageously easily blurred. Therefore, it is difficult to obtain a clear acoustic image while attaining power saving.

### SUMMARY OF THE INVENTION

The present invention has been proposed in order to solve the aforementioned problem, and an object of the present invention is to provide a photoacoustic imager capable of obtaining a clear acoustic image while attaining power saving.

A photoacoustic imager according to an aspect of the present invention includes a light source portion including a light-emitting element, a detection portion for detecting an acoustic wave generated from a detection object in a specimen absorbing light applied from the light source portion, a signal processing portion processing a signal detected by the detection portion and a light source driving circuit making the light source portion perform a pulse emission by controlling power supplied to the light source portion, and is configured to decide the width of a pulse on the basis of a detection sound wave frequency band of the detection portion and to decide the number of pulses in one cycle on the basis of the bandwidth of a detection sound wave frequency of the detection portion.

As hereinabove described, the photoacoustic imager according to the aspect of the present invention is configured to decide the width of the pulse on the basis of the detection sound wave frequency band of the detection portion and to decide the number of pulses in one cycle on the basis of the bandwidth of the detection sound wave frequency of the detection portion, whereby an acoustic wave generated by the pulse emission can be set to a frequency in a detection acoustic frequency band of the detection portion. Thus, the detection portion can efficiently detect the acoustic wave also when the sound pressure of the acoustic wave is reduced due to reduction of the output of the light source portion. Consequently, the photoacoustic imager can obtain a clear acoustic wave while attaining power saving by reducing the output of the light source portion. Further, the light source portion may not be set to a high output, whereby the photoacoustic imager can be miniaturized. In addition, the light source portion may not apply high-output light, whereby a burden on the specimen can be reduced.

The photoacoustic imager according to the aforementioned aspect is preferably configured to decide the width of the pulse so that a peak value of the detection sound wave frequency band of the detection portion becomes a peak value of a frequency characteristic of the pulse emission of the light source portion while increasing the number of pulses when the bandwidth of the detection sound wave frequency of the detection portion is small and setting the number of pulses small when the bandwidth of the detection sound wave frequency of the detection portion is large. According to this structure, the frequency of the peak value of the acoustic wave generated by the pulse emission can be matched with that of a peak value of the detection acoustic frequency band of the detection portion, and the band of the frequency of the acoustic wave generated by the pulse emission can be matched with the detection acoustic frequency band of the detection portion. Thus, the detection portion can more efficiently detect the acoustic wave.

In this case, the photoacoustic imager preferably decides the number of pulses as 1 when 1/(2×T)<(bandwidth of detection sound wave frequency) assuming that T represents the width of the pulse. According to this structure, the number of pulses can be reduced when the bandwidth of the detection sound wave frequency of the detection portion is large.

The aforementioned photoacoustic imager deciding the width of the pulse so that the peak value of the detection sound wave frequency band of the detection portion becomes the peak value of the frequency characteristic of the pulse emission preferably decides the number of pulses as n satisfying 1/((n+1)×T)<(bandwidth of detection sound wave frequency)≦1/(n×T) assuming that T represents the width of the pulse and n represents an integer of at least 2. According to this structure, the number of pulses can be increased when the bandwidth of the detection sound wave frequency of the detection portion is small.

The photoacoustic imager according to the aforementioned aspect is preferably configured to decide the width of the pulse so that the widths of a plurality of pulses are substantially equal to each other in a case where the light source portion performs a plurality of pulse emissions in one cycle. According to this structure, the sound pressure of the acoustic wave of the frequency responsive to the width of the pulse can be effectively increased, whereby the detection portion can further efficiently detect the acoustic wave.

The photoacoustic imager according to the aforementioned aspect is preferably configured to decide the width of the pulse to be at least the width between two continuous pulses in a case where the light source portion performs a plurality of pulse emissions in one cycle. According to this structure, the interval between acoustic waves generated for the respective pulses can be reduced, whereby the width of a signal of the detected acoustic wave can be prevented from enlargement when the signal is integrated. Thus, depth resolution can be prevented from reduction.

In the photoacoustic imager according to the aforementioned aspect, the signal processing portion is preferably configured to integrate a signal of an acoustic wave generated every pulse and to synthesize such signals into one signal in a case where the light source portion performs a plurality of pulse emissions in one cycle. According to this structure, the intensity of the signal of the acoustic wave can be enlarged, whereby the photoacoustic imager can obtain a clear acoustic image. In the photoacoustic imager according to the aforementioned aspect, the signal processing portion is preferably configured to recognize the shape of a substance in the specimen and to form an image by synthesizing images formed by acoustic waves based on a plurality of pulse emissions in a case where the light source portion performs the plurality of pulse emissions in one cycle. According to this structure, the photoacoustic imager can display a forward end portion or a side surface position of the substance in an image without increasing the output of the light source portion.

In this case, the signal processing portion is preferably configured to reduce a depth direction to 1/(number of pulses) with respect to the formed image of the substance. According to this structure, resolution of the image obtained by integrating the acoustic wave responsive to the pulse can be increased also when the resolution of the image in the depth direction is slightly lowered.

In the aforementioned photoacoustic imager recognizing the shape of the substance in the specimen and forming the image, the signal processing portion is preferably configured to shift and correct the position of the substance in a depth direction. According to this structure, accuracy of the position of the substance in the depth direction can be increased.

In this case, the signal processing portion is preferably configured to shift and correct the image of the substance in a direction where the depth is smaller by Yc=(cycle of pulse)×(sound velocity in specimen)×(number of pulses−1)/2 with respect to the depth direction. According to this structure, the position of the substance in the depth direction can be easily corrected on the basis of this equation.

In the aforementioned photoacoustic imager recognizing the shape of the substance in the specimen and forming the image, the detection portion is preferably configured to detect the acoustic wave generated from the detection object in the specimen, to transmit an ultrasonic wave to the specimen and to receive the ultrasonic wave reflected in the specimen, and the signal processing portion is preferably configured to superpose an ultrasonic image resulting from the ultrasonic wave received by the detection portion and the image of the substance resulting from the acoustic wave. According to this structure, the photoacoustic imager can obtain an image displaying the position of the substance in the specimen.

In the photoacoustic imager according to the aforementioned aspect, the signal processing portion is preferably configured to acquire a detection sound wave frequency band responsive to the detection portion, to decide the width of the pulse on the basis of the acquired detection sound wave frequency band of the detection portion and to decide the number of pulses in one cycle on the basis of the bandwidth of a detection sound wave frequency of the detection portion. According to this structure, the detection portion can efficiently detect the acoustic wave also when the detection acoustic frequency band varies with the detection portion.

In this case, the signal processing portion is preferably configured to acquire the detection sound wave frequency band responsive to the detection portion in a case where a power source for the light source portion and the detection portion is brought into an ON-state from an OFF-state. According to this structure, the signal processing portion acquires the detection acoustic frequency band responsive to the detection portion also when the detection portion is exchanged while the power source is in an OFF-state, whereby the detection portion can efficiently detect the acoustic wave.

The photoacoustic imager according to the aforementioned aspect preferably decides the width T of the pulse as T=1/(2×Fa) assuming that Fa represents the center frequency of the detection sound wave frequency band. According to this structure, the photoacoustic imager can easily decide the width T of the pulse on the basis of this equation.

In the photoacoustic imager according to the aforementioned aspect, the pulse generated from the light source portion preferably includes a pulse of a rectangular wave, and the photoacoustic imager is preferably configured to decide the width of the pulse of the rectangular wave on the basis of the detection sound wave frequency band of the detection portion and to decide the number of pulses of rectangular waves in one cycle on the basis of the bandwidth of the detection sound wave frequency of the detection portion. According to this structure, the detection portion can efficiently detect the acoustic wave also when employing the pulse of the rectangular wave allowing relatively easy signal generation.

In the photoacoustic imager according to the aforementioned aspect, the pulse generated from the light source portion preferably includes a pulse of a triangular wave, and the photoacoustic imager is preferably configured to decide the width of the bottom of the pulse of the triangular wave on the basis of the detection sound wave frequency band of the detection portion and to decide the number of pulses of triangular waves in one cycle on the basis of the bandwidth of the detection sound wave frequency of the detection portion. According to this structure, the detection portion can efficiently detect the acoustic wave also when employing the pulse of the triangular wave whose shape is more approximate to that of a sine wave as compared with the rectangular wave.

In the photoacoustic imager according to the aforementioned aspect, the light-emitting element of the light source portion is preferably constituted of a light-emitting diode element. According to this structure, power consumption in the light source portion can be reduced and the photoacoustic imager can be miniaturized as compared with a case where the light source portion is constituted of a solid laser.

In the photoacoustic imager according to the aforementioned aspect, the light-emitting element of the light source portion is preferably constituted of a semiconductor laser element. According to this structure, power consumption in the light source portion can be reduced and the photoacoustic imager can be miniaturized as compared with the case where the light source portion is constituted of a solid laser. Further, the light source portion can apply a laser beam having relatively high directivity to the specimen, whereby the same can apply most part of light from the semiconductor laser element to the specimen.

In the photoacoustic imager according to the aforementioned aspect, the light-emitting element of the light source portion is preferably constituted of an organic light-emitting diode element. According to this structure, power consumption in the light source portion can be reduced and the photoacoustic imager can be miniaturized as compared with the case where the light source portion is constituted of a solid laser. Further, the light source portion provided with the light-emitting element can be easily miniaturized by employing the organic light-emitting diode element easily reducible in thickness.

According to the present invention, as hereinabove described, the photoacoustic imager can obtain a clear acoustic image while attaining power saving.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of a photoacoustic imager according to an embodiment of the present invention;

FIG. 2 is a perspective view showing the structure of the photoacoustic imager according to the embodiment of the present invention;

FIG. 3 illustrates exemplary spectral characteristics of a detection portion of the photoacoustic imager according to the embodiment of the present invention;

FIG. 4 illustrates the frequency characteristic of a pulse of a rectangular wave whose pulse number is 1 in the photoacoustic imager according to the embodiment of the present invention;

FIG. 5 illustrates the frequency characteristic of a pulse of a rectangular wave whose pulse number is 2 in the photoacoustic imager according to the embodiment of the present invention;

FIG. 6 illustrates the frequency characteristic of a pulse of a rectangular wave whose pulse number is 3 in the photoacoustic imager according to the embodiment of the present invention;

FIG. 7 illustrates the frequency characteristic of a pulse of a triangular wave whose pulse number is 2 in the photoacoustic imager according to the embodiment of the present invention;

FIG. 8 is a diagram for illustrating integration of an acoustic wave in the photoacoustic imager according to the embodiment of the present invention;

FIG. 9 is a diagram for illustrating image synthesis processing in the photoacoustic imager according to the embodiment of the present invention;

FIG. 10 is a flow chart for illustrating observation processing in the photoacoustic imager according to the embodiment of the present invention;

FIG. 11 is a block diagram showing the structure of a photoacoustic imager according to a first modification of the embodiment of the present invention; and

FIG. 12 is a block diagram showing the structure of a photoacoustic imager according to a second modification of the embodiment of the present invention.

### DESCRIPTION OF THE PREFERRED EMBODIMENTS

An embodiment of the present invention is now described with reference to the drawings.

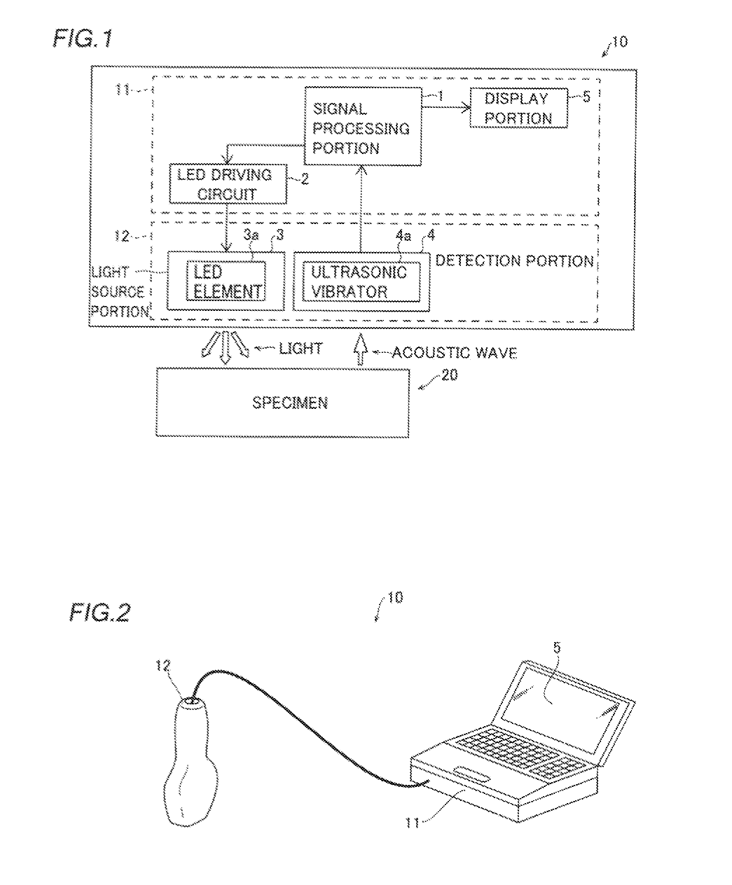

First, the structure of a photoacoustic imager 10 according to the embodiment of the present invention is described with reference to FIGS. 1 to 9.

As shown in FIG. 1, the photoacoustic imager 10 according to the embodiment of the present invention includes a signal processing portion 1, an LED (light-emitting diode) driving circuit 2, a light source portion 3, a detection portion 4 and a display portion 5. The signal processing portion 1, the LED driving circuit 2 and the display portion 5 are provided on a body portion 11, as shown in FIGS. 1 and 2. The light source portion 3 and the detection portion 4 are provided on a probe 12. The body portion 11 and the probe 12 are connected with each other by a wire transmitting power and signals. The light source portion 3 includes a plurality of LED elements (light-emitting diode elements) 3a. The detection portion 4 includes a plurality of ultrasonic vibrators 4a. The LED driving circuit 2 is an example of the “light source driving circuit” in the present invention, and the LED elements 3a are examples of the “light-emitting element” in the present invention.

The photoacoustic imager 10 is configured to apply light to a specimen 20 such as a human body from the light source portion 3 and to detect an ultrasonic wave (acoustic wave) generated from a detection object (not shown) in the specimen 20 absorbing the applied light with the detection portion 4. Further, the photoacoustic imager 10 is configured to be capable of imaging the detection object on the basis of the acoustic wave detected by the detection portion 4. In addition, the photoacoustic imager 10 is so configured that the ultrasonic vibrators 4a emit ultrasonic waves toward the specimen 20 and the detection portion 4 (the ultrasonic vibrators 4a) detects the ultrasonic waves reflected by the detection object in the specimen 20. Further, the photoacoustic imager 10 is configured to be capable of imaging the detection object on the basis of the reflected ultrasonic waves detected by the detection portion 4.

Throughout the specification, the term “ultrasonic wave” denotes a sound wave (elastic wave) whose frequency is too high to be audible to a normal human ear, i.e., sound wave (elastic wave) whose frequency is at least about 16000 Hz. Throughout the specification, further, an ultrasonic wave generated due to absorption of light by the detection object in the specimen 20 is referred to as an “acoustic wave”, while an ultrasonic wave generated by the detection portion 4 (the ultrasonic vibrators 4a) and reflected by the detection object in the specimen 20 is referred to as an “ultrasonic wave”, for the convenience of illustration.

The signal processing portion 1 includes a CPU and a storage portion such as a ROM or a RAM, and is configured to process a signal corresponding to an acoustic wave or an ultrasonic wave detected by the detection portion 4. The signal processing portion 1 is configured to specify the detection object and form an image thereof on the basis of a signal corresponding to an acoustic wave or an ultrasonic wave generated by the detection object in the specimen 20 and detected by the detection portion 4 in a case of measuring the specimen 20, for example. Further, the signal processing portion 1 is configured to make the display portion 5 display the image of the detection object as formed.

In addition, the signal processing portion 1 is configured to control light emission in the light source portion 3 by controlling the LED driving circuit 2. More specifically, the signal processing portion 1 is configured to transmit signals for controlling the timing for making the light source portion 3 emit light, the quantity of light etc. to the LED driving circuit 2.

According to this embodiment, the signal processing portion 1 is configured to decide the width of a pulse on the basis of a detection sound wave frequency band of the detection portion 4 and to decide the number of pulses in one cycle on the basis of the bandwidth of a detection sound wave frequency of the detection portion 4. More specifically, the signal processing portion 1 is configured to decide the width of a pulse so that a peak value of the detection sound wave frequency band of the detection portion 4 becomes a peak value of a frequency characteristic of a pulse emission of the light source portion 3 while increasing the number of pulses when the bandwidth of the detection sound wave frequency of the detection portion 4 is small or setting the number of pulses small when the bandwidth of the detection sound wave frequency of the detection portion 4 is large.

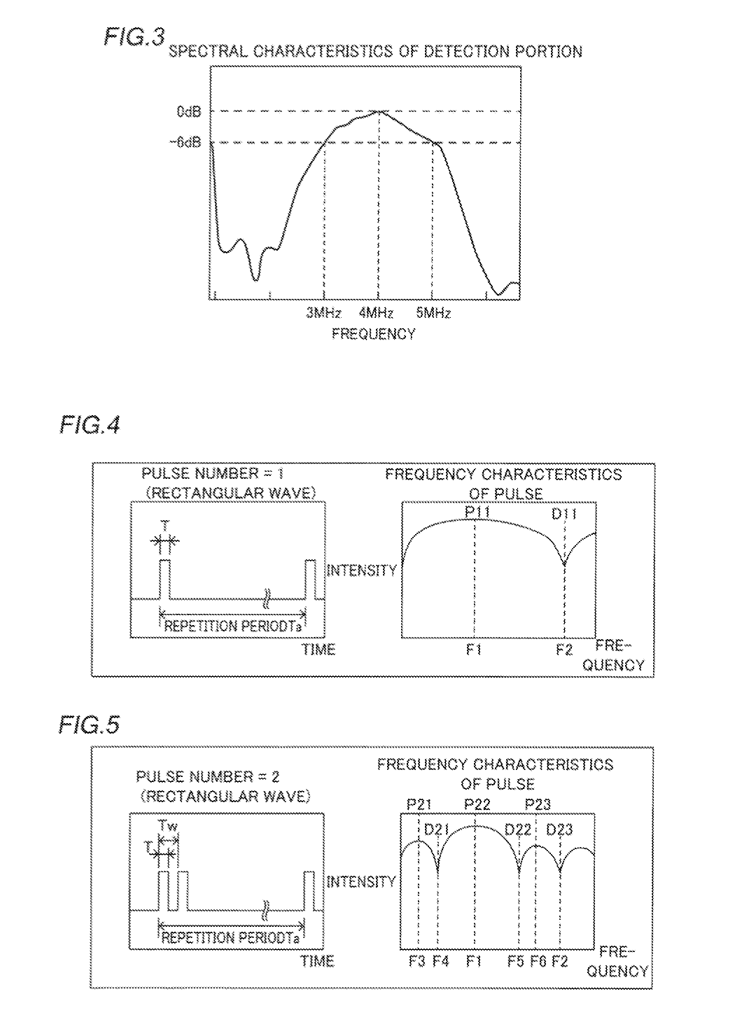

The detection sound wave frequency band of the detection portion 4 is decided from spectral characteristics of the detection portion 4 shown in FIG. 3. The detection portion 4 (the ultrasonic vibrators 4a) has sensitivity of a prescribed frequency band with respect to a detected ultrasonic wave. Referring to FIG. 3, the detection portion 4 has a detection sound wave frequency band of at least about 3 MHz and not more than about 5 MHz with a center (peak) of 4 MHz. For example, the detection sound wave frequency band is set in the range of a frequency band of at least −6 dB (about ½) with reference to a peak value (0 dB).

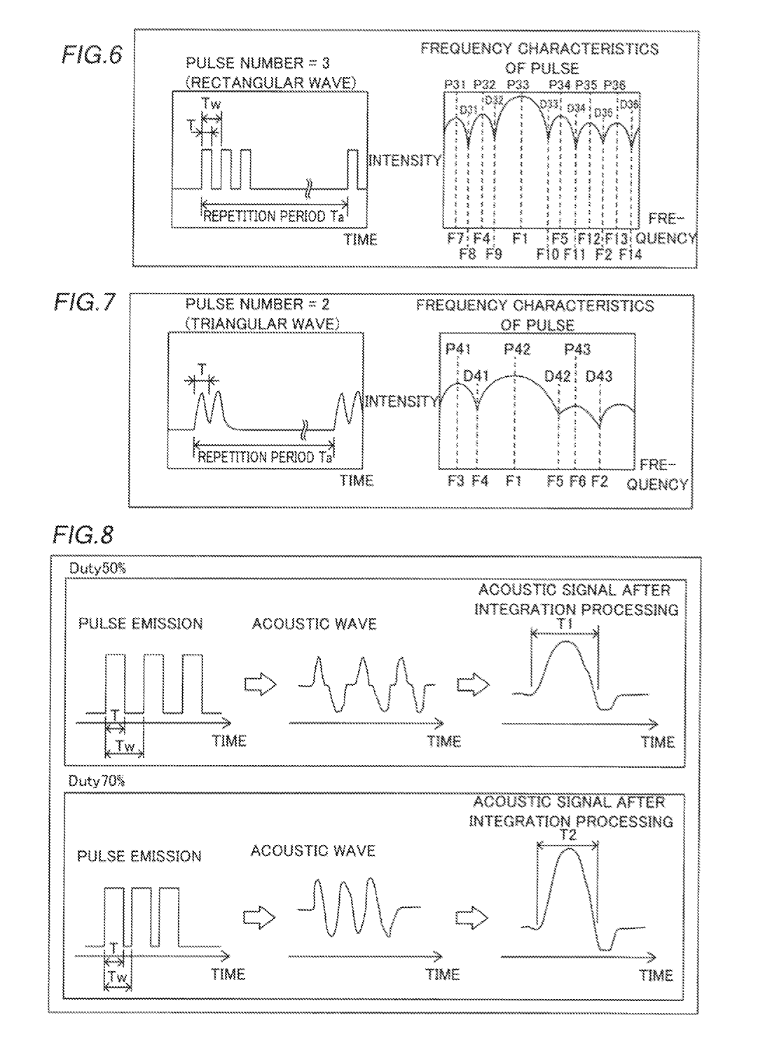

The width of a pulse denotes the time width T of one pulse generated by the light source portion 3, as shown in FIGS. 4 to 6. In other words, the width of a pulse denotes a time from start to end of light emission. The cycle Tw of a pulse denotes a time from start of emission of a pulse to start of emission of a next pulse in continuous pulses, as shown in FIGS. 5 and 6. A repetition period Ta denotes a time interval in one measurement. In other words, a pulse or a plurality of continuous pulses are generated in one cycle of the measurement.

The number of pulses in one cycle and frequency characteristics of pulses are now described with reference to FIGS. 4 to 7. In a case of a rectangular wave whose pulse number is 1 shown in FIG. 4, the frequency characteristic of a pulse having a width T (121 ns, for example) and a repetition period Ta (1 ms, for example) reaches a peak P11 (−21 dBm, for example) at a frequency F1 (=1/(2×T)) (4.1 MHz, for example), and reaches a dip D11 (−52 dBm, for example) at a frequency F2 (=1/T) (8.2 MHz, for example).

In a case of a rectangular wave whose pulse number is 2 shown in FIG. 5, the frequency characteristic of a pulse having a repetition period Ta (1 ms, for example) and a cycle Tw (242 ns, for example) reaches a peak P21 at a frequency F3 (=1/(8×T)) (1.0 MHz, for example), reaches a peak P22 (−15 dBm, for example) at a frequency F1 (=4/(8×T)) (4.1 MHz, for example), and reaches a peak P23 at a frequency F6 (=7/(8×T)) (7.2 MHz, for example). Further, the frequency characteristic reaches a dip D21 (−45 dBm, for example) at a frequency F4 (=1/(4×T)) (2.1 MHz, for example), reaches a dip D22 (−45 dBm, for example) at a frequency F5 (=3/(4×T)) (6.2 MHz, for example), and reaches a dip D23 at a frequency F2 (=4/(4×T)) (8.3 MHz, for example).

In a case of a rectangular wave whose pulse number is 3 shown in FIG. 6, the frequency characteristic of a pulse having a width T (121 ns, for example), a repetition period Ta (1 ms, for example) and a cycle Tw (242 ns, for example) reaches a peak P31 at a frequency F7 (=1/(12×T)) (0.69 MHz, for example), reaches a peak P32 at a frequency F4 (=3/(12×T)) (2.1 MHz, for example), reaches a peak P33 (−11 dBm, for example) at a frequency F1 (=6/(12×T)) (4.1 MHz, for example), reaches a peak P34 at a frequency F5 (=9/(12×T)) (6.2 MHz, for example), reaches a peak P35 at a frequency F12 (=11/(12×T)) (7.6 MHz, for example), and reaches a peak P36 at a frequency F13 (=13/(12×T)) (9.0 MHz, for example). Further, the frequency characteristic reaches a dip D31 at a frequency F8 (=1/(6×1)) (1.4 MHz, for example), reaches a dip D32 (−40 dBm, for example) at a frequency F9 (=2/(6×T)) (2.8 MHz, for example), reaches a dip D33 (−30 dBm, for example) at a frequency F10 (=4/(6×T)) (5.5 MHz, for example), reaches a dip D34 at a frequency F11 (=5/(6×T)) (6.9 MHz, for example), and reaches a dip D36 at a frequency F14 (=7/(6×T)) (9.6 MHz, for example).

As hereinabove described, the frequency characteristics of pulses vary with the number of pulses subjected to emission. In other words, the peak value at the frequency F1 (=1/(2×T)) is increased (P11<P22<P33) when the number of pulses is increased. Further, the band from a dip to another dip in the frequency characteristic is reduced when the number of pulses is increased.

In a case of a triangular wave whose pulse number is 2 shown in FIG. 7, the frequency characteristic of a pulse having a width T (121 ns, for example) (the width of the bottom), a repetition period Ta (1 ms, for example) and a cycle Tw (242 ns, for example) reaches a peak P41 at a frequency F3 (=1/(8×T)) (1.0 MHz, for example), reaches a peak P42 at a frequency F1 (=4/(8×T)) (4.1 MHz, for example), and reaches a peak P43 at a frequency F6 (=7/(8×T)) (7.2 MHz, for example). Further, the frequency characteristic reaches a dip D41 at a frequency F4 (=1/(4×T)) (2.1 MHz, for example), reaches a dip D42 at a frequency F5 (=3/(4×T)) (6.2 MHz, for example), and reaches a dip D43 at a frequency F2 (=4/(4×T)) (8.3 MHz, for example).

In other words, it is understood that peaks and dips appear at the same frequencies both of the cases where the pulses have rectangular and triangular waveforms.

According to this embodiment, the signal processing portion 1 is configured to decide the widths of pulses so that the widths of a plurality of pulses are substantially equal to each other when the light source portion 3 performs a plurality of pulse emissions in one cycle. The signal processing portion 1 is also configured to decide the widths of pulses so that the widths of the pulses are at least the width between two continuous pulses when the light source portion 3 performs a plurality of pulse emissions in one cycle. In other words, the signal processing portion 1 sets the widths of the pulses so that a duty ratio expressed as (pulse width T)/(pulse cycle Tw) is at least 50%.

Further, the signal processing portion 1 is configured to integrate a signal of an acoustic wave generated every pulse when the light source portion 3 performs a plurality of pulse emissions in one cycle. In other words, the signal processing portion 1 is configured to integrate signals of acoustic waves generated by a plurality of pulses and to synthesize the same into one signal increased in intensity. For example, the signal processing portion 1 integrates signals of acoustic waves based on three continuous pulse emissions and synthesizes the same into one signal, as shown in FIG. 8.

Referring to FIG. 8, the width (time) of an acoustic signal after integration is T1 when the duty ratio (T/Tw) is 50%. When the duty ratio (T/Tw) is 70%, the width (time) of the acoustic signal after integration is T2 smaller than T1. In other words, the width (time) of the acoustic signal after integration is reduced when the duty ratio is increased, and hence the resolution of the specimen 20 in the depth direction can be improved.

The signal processing portion 1 is configured to recognize the shape of a needle in the specimen 20 and to form an image by synthesizing images formed by acoustic waves based on a plurality of pulse emissions when the light source portion 3 performs the plurality of pulse emissions in one cycle. The needle is an example of the “substance” in the present invention.

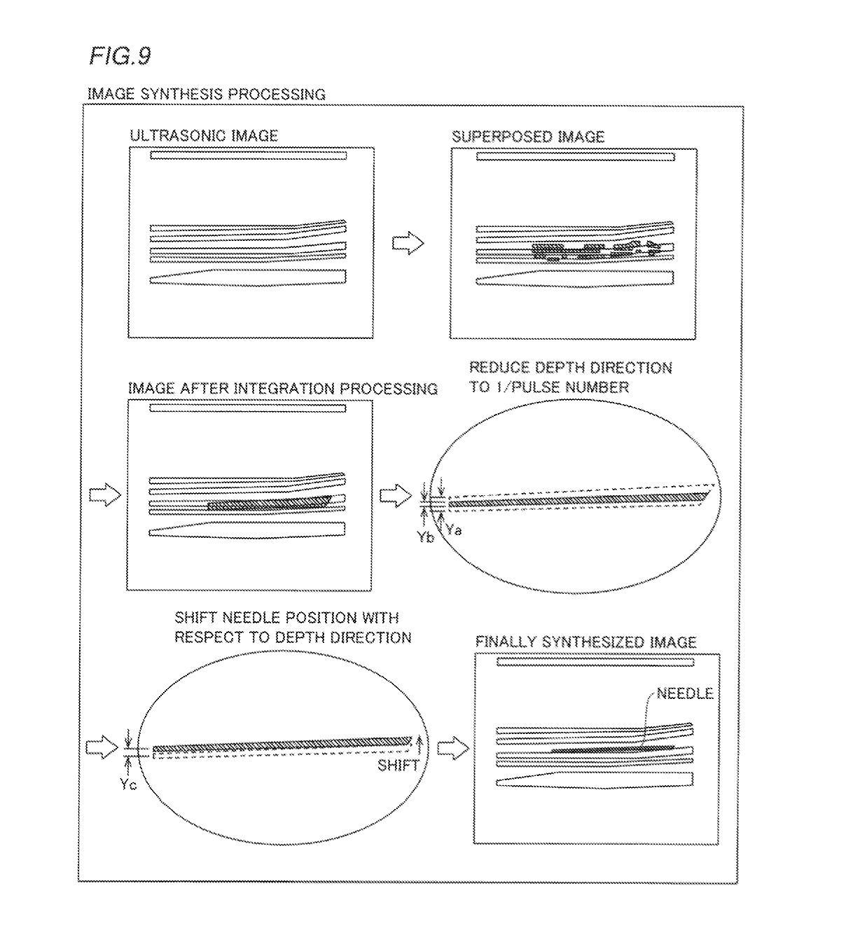

More specifically, it is difficult to observe a needle position by multiple reflection in an image acquired by transmitting/receiving an ultrasonic wave from/in the detection portion 4, as shown in FIG. 9. In an image acquired by transmitting three continuous optical pulses to this ultrasonic image and receiving acoustic waves, three lights responsive to the pulses are formed in the depth direction.

While the image acquired by integrating the acoustic waves responsive to the pulses shows a single needle, resolution in the depth direction is slightly lowered (the needle is thickly displayed). Therefore, the depth direction is reduced to 1/(pulse number) with respect to the image of the needle formed after receiving and integrating the acoustic waves. Thus, the thickness of the needle in the depth direction is reduced from Ya to Yb (=Ya/pulse number).

Then, the needle position is shifted and corrected. More specifically, the image of the needle is shifted in a direction smaller in depth by Yc=(pulse cycle Tw)×(sound velocity in specimen 20)×(pulse number−1)/2 with respect to the depth direction. An image obtained by processing the image of the needle is further superposed on the ultrasonic image and the acoustic image and displayed on the display portion 5 as a final synthetic image. Thus, the display portion 5 can precisely display the image of the needle.

The LED driving circuit 2 is configured to control current flowing in the plurality of LED elements 3a of the light source portion 3 on the basis of control by the signal processing portion 1. Further, the LED driving circuit 2 is configured to make the light source portion 3 perform pulse emissions. More specifically, the LED driving circuit 2 is configured to control ON- and OFF-states of the current flowing in the LED elements 3a and to control the magnitude (current value) of the current on the basis of control by the signal processing portion 1.

The light source portion 3 is configured to apply light toward the specimen 20. The LED elements 3a of the light source portion 3 are configured to generate light (light of about 700 nm to about 1000 nm, for example) of substantially identical wavelengths.

The detection portion 4 having the ultrasonic vibrators 4a is so configured that the ultrasonic vibrators 4a are vibrated by acoustic waves thereby detecting the acoustic waves (ultrasonic waves). Further, the detection portion 4 is configured to output signals corresponding to the detected acoustic waves to the signal processing portion 1. In addition, the detection portion 4a (the ultrasonic vibrators 4a) is configured to be capable of generating ultrasonic waves.

The display portion 5 is configured to be capable of displaying an image of the detection object in the specimen and various screens (an operation screen, an information screen etc.) on the basis of control by the signal processing portion 1.

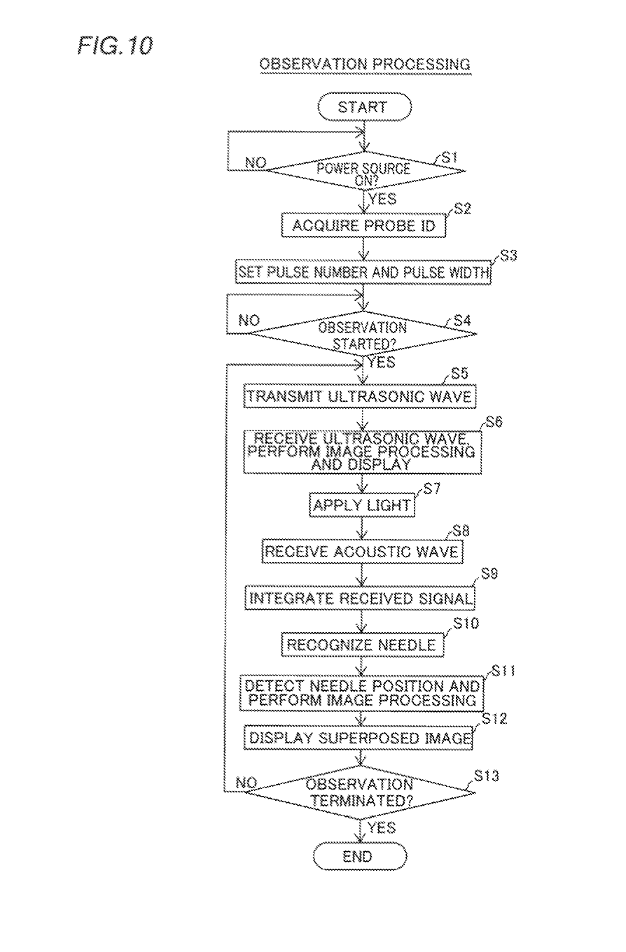

Observation processing by the signal processing portion 1 of the photoacoustic imager 10 is now described with reference to FIG. 10.

First, the signal processing portion 1 determines whether or not the power source for the light source portion 3 and the detection portion 4 is ON at a step S1. When the power source is OFF, the signal processing portion 1 repeats the determination at the step S1 until the power source for the light source portion 3 and the detection portion 4 is turned on. When the power source is ON, on the other hand, the signal processing portion 1 advances to a step S2, and acquires a probe ID (the ID of the detection portion 4). Further, the signal processing portion 1 acquires information of the detection portion 4 in response to the probe ID. The information of the detection portion 4 includes a type name, the channel number of the ultrasonic vibrators 4a, the pitch of the ultrasonic vibrators 4a, the center frequency Fa (0 dB) of the detection sound wave frequency band, the bandwidth (−6 dB) of the detection sound wave frequency, a start frequency Fb (−30 dB) and a stop frequency Fc (−30 dB).

At a step S3, the signal processing portion 1 decides and sets the number N of pulses generated by the light source portion 3 and the pulse width T. The signal processing portion 1 decides the pulse width T as T=1/(2×Fa). When the center frequency Fa is 4 MHz, for example, the pulse width T is 125 ns. The signal processing portion 1 decides the pulse number N on the basis of the following Table 1:

TABLE 1

| | Pulse Number N |
|---|---|
| 1/(2 × T) < Fc − Fb | decided as 1 |
| 1/(3 × T) < Fc − Fb ≦ 1/(2 × T) | decided as 2 |
| 1/(4 × T) < Fc − Fb ≦ 1/(3 × T) | decided as 3 |
| 1/(5 × T) < Fc − Fb ≦ 1/(4 × T) | decided as 4 |
| . | . |
| . | . |
| . | . |
| 1/((n + 1) × T) < Fc − Fb ≦ 1/(n × T) | decided as n |

When the center frequency Fa is 4 MHz, the start frequency Fb is 2 MHz and the stop frequency Fc is 6 MHz, for example, the pulse width T is 125 ns, as described above. Further, Fc−Fb=4 MHz and 1/(2×T)=4 MHz and 1/(3×T)=2.6 MHz, and hence Fc−Fb is in the range of 1/(3×T)<Fc−Fb 1/(2×T). Therefore, the signal processing portion 1 decides the pulse number N as 2 in this case. Fc−Fb is an example of the “bandwidth of the detection sound wave frequency” in the present invention. 1/(2×T) is obtained from the width between dips (see FIG. 5 (F5−F4, for example)) of the frequency characteristic in the case where the pulse number is 2. Similarly, 1/(n×T) is obtained from the width between dips of a frequency characteristic in a case where the pulse number is n.

At a step S4, the signal processing portion 1 determines whether or not observation has been started. More specifically, the signal processing portion 1 determines whether or not observation has been started by an operation of a user. When no observation has been started, the signal processing portion 1 repeats the determination at the step S4 until the user starts the observation. When the observation has been started, on the other hand, the signal processing portion 1 advances to a step S5, and controls the detection portion 4 (the ultrasonic vibrators 4a) to transmit ultrasonic waves to the specimen 20.

At a step S6, the signal processing portion 1 controls the detection portion 4 to receive the ultrasonic waves reflected in the specimen 20, performs image processing, and controls the display portion 5 to display an image. Thus, the display portion 5 displays an ultrasonic image.

At a step S7, the signal processing portion 1 controls the light source portion 3 to apply light of pulses decided at the step S3 to the specimen 20. At a step S8, the signal processing portion 1 controls the detection portion 4 to receive an acoustic wave generated by the specimen 20 on the basis of the light of the pulses.

At a step S9, the signal processing portion 1 integrates a received signal of the acoustic wave. At a step S10, the signal processing portion 1 recognizes the needle. At a step S11, the signal processing portion 1 detects the needle position. Further, the signal processing portion 1 performs image processing on the basis of the detected needle position. At a step 12, the signal processing portion 1 controls the display portion 5 to display a superposed image obtained by superposing the ultrasonic image and the acoustic image subjected to the integration and the image processing.

At a step S13, the signal processing portion 1 determines whether or not the observation has been terminated. More specifically, the signal processing portion 1 determines whether or not the observation has been terminated by an operation of the user. When the observation has not been terminated, the signal processing portion 1 returns to the step S5. When the observation has been terminated, on the other hand, the signal processing portion 1 terminates the observation processing.

According to this embodiment, the following effects can be attained:

According to this embodiment, as hereinabove described, the photoacoustic imager 10 is configured to decide the width of a pulse on the basis of the detection sound wave frequency band of the detection portion 4 and to decide the number of pulses in one cycle on the basis of the bandwidth of the detection sound wave frequency of the detection portion 4, whereby the same can set an acoustic wave generated by pulse emission to a frequency in a detection acoustic frequency band of the detection portion 4. Thus, the detection portion 4 can efficiently detect the acoustic wave also when the sound pressure of the acoustic wave is reduced due to reduction of the output of the light source portion 3. Consequently, the photoacoustic imager 10 can obtain a clear acoustic image while attaining power saving by reducing the output of the light source portion 3. Further, the light source portion 3 may not be set to a high output, whereby the photoacoustic imager 10 can be miniaturized. In addition, the light source portion 3 may not apply high-output light, whereby a burden on the specimen 20 can be reduced.

According to this embodiment, as hereinabove described, the photoacoustic imager 10 is configured to decide the width of a pulse so that the peak value of the detection sound wave frequency band of the detection portion 4 becomes the peak value of the frequency characteristic of the pulse emission of the light source portion 3 while increasing the number of pulses when the bandwidth of the detection sound wave frequency of the detection portion 4 is small and setting the number of pulses small when the bandwidth of the detection sound wave frequency of the detection portion 4 is large. Thus, the frequency of the peak value of the acoustic wave generated by the pulse emission can be matched with that of a peak value of the detection acoustic frequency band of the detection portion 4, and the band of the frequency of the acoustic wave generated by the pulse emission can be matched with the detection acoustic frequency band of the detection portion 4. Thus, the detection portion 4 can more efficiently detect the acoustic wave.

According to this embodiment, as hereinabove described, the photoacoustic imager 10 decides the number of pulses as 1 when 1/(2×T)<(bandwidth of detection sound wave frequency) assuming that T represents the pulse width. Thus, the number of pulses can be reduced when the bandwidth of the detection sound wave frequency of the detection portion 4 is large.

According to this embodiment, as hereinabove described, the photoacoustic imager 10 decides the number of pulses as n satisfying 1/((n+1)×T)<(bandwidth of detection sound wave frequency) assuming that T represents the pulse width and n represents an integer of at least 2. Thus, the number of pulses can be increased when the bandwidth of the detection sound wave frequency of the detection portion 4 is small.

According to this embodiment, as hereinabove described, the photoacoustic imager 10 is configured to decide the widths of pulses so that the widths of a plurality of pulses are substantially equal to each other when the light source portion 3 performs a plurality of pulse emissions in one cycle. Thus, the sound pressure of an acoustic wave of a frequency responsive to the pulse width can be effectively increased, whereby the detection portion 4 can more efficiently detect the acoustic wave.

According to this embodiment, as hereinabove described, the photoacoustic imager 10 is configured to decide the widths of pulses to be at least the width between two continuous pulses when the light source portion 3 performs a plurality of pulse emissions in one cycle. Thus, the interval between acoustic waves generated for the respective pulses can be reduced, whereby the width of a signal of the detected acoustic wave can be prevented from enlargement when the signal is integrated. Thus, depth resolution can be prevented from reduction.

According to this embodiment, as hereinabove described, the signal processing portion 1 is configured to integrate a signal of an acoustic wave generated every pulse and to synthesize such signals into one signal when the light source portion 3 performs a plurality of pulse emissions in one cycle. Thus, the intensity of signals of acoustic waves can be increased, whereby the photoacoustic imager 10 can obtain a clear acoustic image.

According to this embodiment, as hereinabove described, the signal processing portion 1 is configured to recognize the shape of a needle in the specimen 20 and to form an image by synthesizing images formed by acoustic waves based on a plurality of pulse emissions when the light source portion 3 performs the plurality of pulse emissions in one cycle. Thus, the photoacoustic imager 10 can display a forward end portion or a side surface position of the needle in an image without increasing the output of the light source portion 3.

According to this embodiment, as hereinabove described, the signal processing portion 1 is configured to reduce the depth direction to 1/(pulse number) with respect to the formed image of the needle. Thus, resolution can be increased also when the resolution of the image acquired by integrating acoustic waves responsive to pulses in the depth direction is slightly lowered.

According to this embodiment, as hereinabove described, the signal processing portion 1 is configured to shift and correct the position of the needle in the depth direction. Thus, accuracy of the position of the needle in the depth direction can be improved.

According to this embodiment, as hereinabove described, the signal processing portion 1 is configured to shift and correct the position of the needle in a direction smaller in depth by Yc=(pulse cycle Tw)×(sound velocity in specimen 20)×(pulse number−1)/2 with respect to the depth direction. Thus, the signal processing portion 1 can easily correct the position of the needle in the depth direction on the basis of this equation.

According to this embodiment, as hereinabove described, the detection portion 4 is configured to detect an acoustic wave generated from the detection object in the specimen 20, to transmit an ultrasonic wave to the specimen 20 and to receive the ultrasonic wave reflected in the specimen 20. Further, the signal processing portion 1 is configured to superpose the ultrasonic image resulting from the ultrasonic wave received by the detection portion 4 and the image of the needle resulting from the acoustic wave. Thus, the photoacoustic imager 10 can obtain an image displaying the position of the needle in the specimen 20.

According to this embodiment, as hereinabove described, the signal processing portion 1 is configured to acquire the detection sound wave frequency band responsive to the detection portion 4, to decide the width of a pulse on the basis of the acquired detection sound wave frequency band of the detection portion 4, and to decide the number of pulses in one cycle on the basis of the bandwidth of the detection sound wave frequency of the detection portion 4. Thus, the detection portion 4 can efficiently detect the acoustic wave also when the detection sound wave frequency band varies with the detection portion 4.

According to this embodiment, as hereinabove described, the signal processing portion 1 is configured to acquire the detection sound wave frequency band responsive to the detection portion 4 when the power source for the light source portion 3 and the detection portion 4 is brought into an ON-state from an OFF-state. Thus, the signal processing portion 1 acquires the detection sound wave frequency band responsive to the detection portion 4 also when the detection portion 4 is exchanged while the power source is in an OFF-state, whereby the detection portion 4 can efficiently detect the acoustic wave.

According to this embodiment, as hereinabove described, the photoacoustic imager 10 decides the pulse width T as T=1/(2×Fa) assuming that Fa represents the center frequency of the detection sound wave frequency band. Thus, the photoacoustic imager 10 can easily decide the pulse width T on the basis of this equation.

According to this embodiment, as hereinabove described, the pulse generated by the light source portion 3 includes a pulse of a rectangular wave, and the photoacoustic imager 10 is configured to decide the width of the pulse of the rectangular wave on the basis of the detection sound wave frequency band of the detection portion 4, and to decide the number of pulses of rectangular waves in one cycle on the basis of the bandwidth of the detection sound wave frequency of the detection portion 4. Thus, the detection portion 4 can efficiently detect the acoustic wave also when the photoacoustic imager 10 employs the pulse of the rectangular wave allowing relatively easy signal generation.

According to this embodiment, as hereinabove described, the pulse generated by the light source portion 3 includes a pulse of a triangular wave, and the photoacoustic imager 10 is configured to decide the width of the bottom of the pulse of the triangular wave on the basis of the detection sound wave frequency band of the detection portion 4, and to decide the number of pulses of triangular waves in one cycle on the basis of the bandwidth of the detection sound wave frequency of the detection portion 4. Thus, the detection portion 4 can efficiently detect the acoustic wave also when employing the pulse of the triangular wave whose shape is more approximate to that of a sine wave as compared with the rectangular wave.

According to this embodiment, as hereinabove described, the light source portion 3 includes the LED elements 3a. Thus, power consumption in the light source portion 3 can be reduced and the photoacoustic imager 10 can be miniaturized as compared with a case where the light source portion 3 is formed by a solid laser.

Although the present invention has been described and illustrated in detail, it is clearly understood that the same is by way of illustration and example only and is not to be taken by way of limitation, the spirit and scope of the present invention being limited only by the terms of the appended claims.

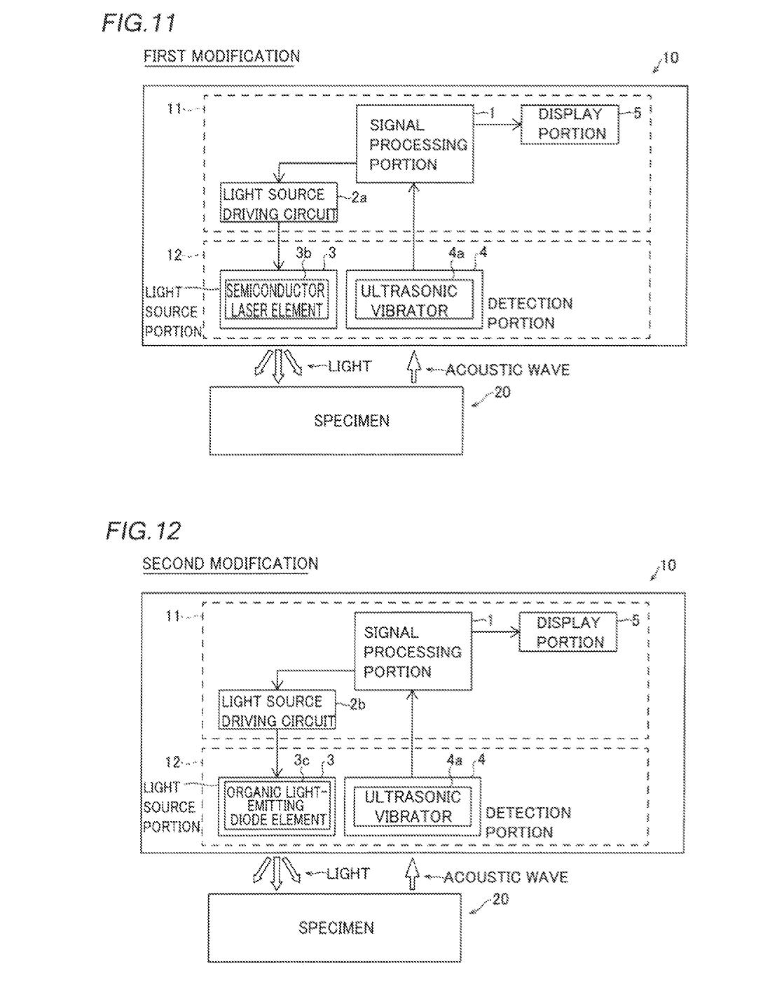

For example, while the aforementioned embodiment employs the LED elements (light-emitting diode elements) as the light-emitting elements of the light source portion according to the present invention, the present invention is not restricted to this. According to the present invention, semiconductor laser elements 3b may alternatively be employed as the light-emitting elements, as in a first modification shown in FIG. 11. In this case, a light source driving circuit 2a may be provided for driving the semiconductor laser elements 3b.

Further alternatively, organic light-emitting diode elements 3c may be employed as the light-emitting elements, as in a second modification shown in FIG. 12. In this case, a light source driving circuit 2b may be provided for driving the organic light-emitting diode elements 3c.

In addition, elements other than the light-emitting diode elements, the semiconductor laser elements and the organic light-emitting diode elements may be employed as the light-emitting elements of the light source portion.

While the photoacoustic imager 10 decides the pulse number by setting the bandwidth of the detection sound wave frequency on the basis of the level of −30 dB in the aforementioned embodiment, the present invention is not restricted to this. According to the present invention, the photoacoustic imager may alternatively decide the pulse number by setting the bandwidth of the detection sound wave frequency on the basis of a level other than −30 dB. For example, the photoacoustic imager may decide the pulse number by setting the bandwidth of the detection sound wave frequency on the basis of a level of −6 dB.

While the signal processing portion decides the pulse width and the number of pulses in one cycle in the aforementioned embodiment, the present invention is not restricted to this. According to the present invention, an element other than the signal processing portion may alternatively decide the pulse width and the number of pulses in one cycle.

While the optical pulse has the rectangular or triangular waveform in the aforementioned embodiment, the present invention is not restricted to this. According to the present invention, the optical pulse may alternatively have a waveform other than the rectangular or triangular waveform. For example, the optical pulse may alternatively have a sine waveform or a trapezoidal waveform.

While the processing of the signal processing portion according to the present invention is described with reference to the flow-driven type flow chart for successively performing processing along a processing flow in the aforementioned embodiment for the convenience of illustration, the present invention is not restricted to this. According to the present invention, the signal processing portion may alternatively perform event-driven processing for executing processing every event. In this case, the signal processing portion may perform complete event-driven processing or a combination of event-driven processing and flow-driven processing.

While the signal processing portion is configured to recognize the shape of the needle in the specimen and to form the image in the aforementioned embodiment, the present invention is not restricted to this. According to the present invention, the signal processing portion may alternatively be configured to recognize the shape of a substance, other than the needle, in the specimen and to form an image.

What is claimed is:

1. A photoacoustic imager comprising:
a light source portion including a light-emitting element;
a detection portion for detecting an acoustic wave generated from a detection object in a specimen absorbing light applied from the light source portion;
a signal processing portion processing a signal detected by the detection portion; and
a light source driving circuit making the light source portion perform a pulse emission by controlling power supplied to the light source portion, and
configured to decide the width of a pulse on the basis of a detection sound wave frequency band of the detection portion and to decide the number of pulses in one cycle on the basis of the bandwidth of a detection sound wave frequency of the detection portion.

2. The photoacoustic imager according to claim 1, configured to decide the width of the pulse so that a peak value of the detection sound wave frequency band of the detection portion becomes a peak value of a frequency characteristic of the pulse emission of the light source portion while increasing the number of pulses when the bandwidth of the detection sound wave frequency of the detection portion is small and setting the number of pulses small when the bandwidth of the detection sound wave frequency of the detection portion is large.

3. The photoacoustic imager according to claim 2, deciding the number of pulses as 1 when 1/(2×T)<(bandwidth of detection sound wave frequency) assuming that T represents the width of the pulse.

4. The photoacoustic imager according to claim 2, deciding the number of pulses as n satisfying 1/((n+1)×T)<(bandwidth of detection sound wave frequency) 1/(n×T) assuming that T represents the width of the pulse and n represents an integer of at least 2.

5. The photoacoustic imager according to claim 1, configured to decide the width of the pulse so that the widths of a plurality of pulses are substantially equal to each other in a case where the light source portion performs a plurality of pulse emissions in one cycle.

6. The photoacoustic imager according to claim 1, configured to decide the width of the pulse to be at least the width between two continuous pulses in a case where the light source portion performs a plurality of pulse emissions in one cycle.

7. The photoacoustic imager according to claim 1, wherein
the signal processing portion is configured to integrate a signal of an acoustic wave generated every pulse and to synthesize such signals into one signal in a case where the light source portion performs a plurality of pulse emissions in one cycle.

8. The photoacoustic imager according to claim 1, wherein
the signal processing portion is configured to recognize the shape of a substance in the specimen and to form an image by synthesizing images formed by acoustic waves based on a plurality of pulse emissions in a case where the light source portion performs the plurality of pulse emissions in one cycle.

9. The photoacoustic imager according to claim 8, wherein
the signal processing portion is configured to reduce a depth direction to 1/(number of pulses) with respect to the formed image of the substance.

10. The photoacoustic imager according to claim 8, wherein
the signal processing portion is configured to shift and correct the position of the substance in a depth direction.

11. The photoacoustic imager according to claim 10, wherein
the signal processing portion is configured to shift and correct the image of the substance in a direction where the depth is smaller by Yc=(cycle of pulse)×(sound velocity in specimen)×(number of pulses−1)/2 with respect to the depth direction.

12. The photoacoustic imager according to claim 8, wherein
the detection portion is configured to detect the acoustic wave generated from the detection object in the specimen, to transmit an ultrasonic wave to the specimen and to receive the ultrasonic wave reflected in the specimen, and
the signal processing portion is configured to superpose an ultrasonic image resulting from the ultrasonic wave received by the detection portion and the image of the substance resulting from the acoustic wave.

13. The photoacoustic imager according to claim 1, wherein
the signal processing portion is configured to acquire a detection sound wave frequency band responsive to the detection portion, to decide the width of the pulse on the basis of the acquired detection sound wave frequency band of the detection portion and to decide the number of pulses in one cycle on the basis of the bandwidth of a detection sound wave frequency of the detection portion.

14. The photoacoustic imager according to claim 13, wherein
the signal processing portion is configured to acquire the detection sound wave frequency band responsive to the detection portion in a case where a power source for the light source portion and the detection portion is brought into an ON-state from an OFF-state.

15. The photoacoustic imager according to claim 1, deciding the width T of the pulse as T=1/(2×Fa) assuming that Fa represents the center frequency of the detection sound wave frequency band.

16. The photoacoustic imager according to claim 1, wherein
the pulse generated from the light source portion includes a pulse of a rectangular wave, and
the photoacoustic imager is configured to decide the width of the pulse of the rectangular wave on the basis of the detection sound wave frequency band of the detection portion and to decide the number of pulses of rectangular waves in one cycle on the basis of the bandwidth of the detection sound wave frequency of the detection portion.

17. The photoacoustic imager according to claim 1, wherein
the pulse generated from the light source portion includes a pulse of a triangular wave, and
the photoacoustic imager is configured to decide the width of the bottom of the pulse of the triangular wave on the basis of the detection sound wave frequency band of the detection portion and to decide the number of pulses of triangular waves in one cycle on the basis of the bandwidth of the detection sound wave frequency of the detection portion.

18. The photoacoustic imager according to claim 1, wherein
the light-emitting element of the light source portion is constituted of a light-emitting diode element.

19. The photoacoustic imager according to claim 1, wherein
the light-emitting element of the light source portion is constituted of a semiconductor laser element.

20. The photoacoustic imager according to claim 1, wherein
the light-emitting element of the light source portion is constituted of an organic light-emitting diode element.
